(19) United States
(12) Patent Application Publication
(10) Pub. No.: US 2025/0276311 A1
(43) Pub. Date: Sep. 4, 2025

(54) Photocatalyst Extrusion Methods, Photocatalyst Extrudates, and Photoreactors Employing Photocatalyst Extrudates

(71) Applicant: Syzygy Plasmonics Inc., Houston, TX (US)

(72) Inventors: Suman Khatiwada, Houston, TX (US); Parisa Shadabipour, Houston, TX (US); Jonathan Morris Chapman, Houston, TX (US); Hossein Robatjazi, Houston, TX (US); Shreya Shah, Houston, TX (US); Danniela Cristina Herrera Gutierrez, Houston, TX (US); Anilkumar Mettu, Houston, TX (US)

(73) Assignee: Syzygy Plasmonics Inc., Houston, TX (US)

(21) Appl. No.: 18/998,496

(22) PCT Filed: Jul. 27, 2023
(86) PCT No.: PCT/US2023/028779

§ 371 Date: Jan. 25, 2025

Related U.S. Application Data
(60) Provisional application No. 63/392,848, filed on Jul. 27, 2022.

(51) Int. Cl. B01J 37/03; B01J 35/39; B01J 35/40; B01J 35/55; B01J 37/00; B01J 37/04; B01J 37/08

(52) U.S. Cl. CPC B01J 37/03; B01J 35/39; B01J 35/40; B01J 35/55; B01J 37/0027; B01J 37/04; B01J 37/08; B01J 2235/10

(57) ABSTRACT

Methods and manufacturing processes for photocatalyst extrusion, extrudate photocatalysts, and photoreactor utilizing extrudate photocatalysts as a photocatalyst packed bed. An example method includes co-precipitating solutions to form a photocatalyst slurry, centrifugating and drying the slurry to form a dried powder, mixing the dried powder with a binder and a porogen and combining with a solvent to form a dough, feeding the dough through an extruder to create extrudates having a predetermined shape and cross-section, drying the extrudate, and thermally treating the extrudate after drying.

### RELATED APPLICATION

This application claims priority to U.S. Provisional Patent Application No. 63/392,848, filed Jul. 27, 2022, the entirety of which is incorporated by reference herein.

### FIELD

This disclosure relates to the field of industrial chemical production, and, in particular, to the design and construction of improved photocatalysts for industrial chemical production.

### BACKGROUND

Thermal catalysis is responsible for the production of approximately 85% of all industry-produced chemicals but requires relatively extreme reaction conditions, including high temperatures and pressures, resulting in reduced process efficiency and a large carbon footprint. Conversely, photocatalysis offers a possibility of reduced overall energy consumption for chemical transformation compared to that of the thermocatalytic counterparts.

Photocatalysis, as used herein, refers to irradiating a chemical process with photons to accelerate the rate of chemical conversion of reactants to selectively form a desired product. Incident photons of sufficient energy and wavelength activate photo-induced reactions by unlocking reaction mechanisms that otherwise may not be accessible via thermally activated processes. Recent developments in photocatalysis include the use of plasmonic nanoparticles that exhibit strong interactions with visible light due to the excitation of electronic oscillations. See, e.g., the following, the contents of each of which is incorporated by reference herein: (1) Robatjazi et al., “Plasmon-Driven Carbon-Fluorine (C(Sp 3)-F) Bond Activation with Mechanistic Insights into Hot-Carrier-Mediated Pathways,” Nat. Catal., 2020, 3 (7), 564-573, https://doi.org/10.1038/s41929-020-0466-5; (2) Zhou et al., “Light-Driven Methane Dry Reforming with Single Atomic Site Antenna-Reactor Plasmonic Photocatalysts,” Nat. Energy, 2020, 5 (1), 61-70, https://doi.org/10.1038/s41560-019-0517-9; and (3) Zhou et al., “Quantifying Hot Carrier and Thermal Contributions in Plasmonic Photocatalysis,” Science, 5 Oct. 2018, 69-72, https://doi.org/10.1126/science.aat6967. These plasmonic nanoparticles offer the possibility of increased efficiency due to accelerating the kinetics of chemical bond activations under illumination while also lowering the overall energy barrier, thus reducing the overall energy consumption for chemical transformation compared to that of the thermocatalytic counterparts. While plasmonic nanoparticles have attracted significant interest in academia for various chemical transformations, known industrial applications are primarily limited to wastewater treatment and purification processes, sensing, imaging, and biomedical applications, many or all of which are liquid-state reactions. See, e.g., Mozia, “Photocatalytic Membrane Reactors (PMRs) in Water and Wastewater Treatment: A Review,” Sep. Purif. Technol., 2010, 73 (2), 71-91, https://doi.org/10.1016/j.seppur.2010.03.021, the entirety of which is incorporated by reference herein. Plasmonic nanoparticle photocatalysis directed to gas-phase reactions in continuous-flow photoreactor systems is less common.

Construction of a photoreactor typically requires the use of transparent materials, e.g., glass, to allow for transmission of photon energy from an external light source to the surface of the photocatalyst. Photoreactors for continuous-flow gas-phase reactors may be subjected to relatively higher pressures (i.e., to accommodate a pressure drop that occurs in the photoreactor) as production is scaled-up. Pressure vessels made with glass materials, however, typically have relatively low pressure ratings due to the inherent material property of glasses. This relatively lower pressure rating (e.g., compared to non-transparent materials, such as metals) has become a limiting factor toward increasing production capacity. In other words, the lower pressure rating of glass-based pressure vessels typically does not allow otherwise optimizing the physical size of the photoreactor (e.g., by increasing its diameter) and gas flow feed rates (e.g., by increasing the feed rates). In addition, the ability to benefit from optimizing the macroscopic shape and size of the powdered photocatalyst materials therein is, in turn, hampered. Therefore, a photocatalyst manufacturing technique that would allow for a lower pressure drop in a photoreactor would better allow for scaling-up production rates.

Manufacturing techniques for photocatalytic materials having controlled physical and optical properties and methods for using them in practical photoreactors are generally not as well known or understood as those used for thermally activated heterogeneous catalysts. Typical photocatalytic materials are fabricated and utilized in the form of thin films. European Patent Publication No. EP1166871A1 discloses a process for manufacturing a photocatalytic sheet and film with a thickness of at least 10 μm comprising a photocatalyst layer and binder, and a functional layer brought to a support using extrusion coating or casting technology. Chinese Patent Publication No. CN103184685A discloses a method for preparing a photocatalytic functional fabric based on TiO2 and its extrusion into composite fiber membrane using an electrospinning method at very high voltages. Other approaches, such as photocatalyst printing of thin films or sheets, have also been suggested for fabricating photocatalytic materials. However, the use of a thin film or sheet of photocatalyst layer is not suitable for chemical conversions at larger scales needed for industrial chemical production.

Supported heterogeneous catalysts are comprised of an active site (often transition metal species in the form of nanoparticle or atomically dispersed species) and a support material (often oxides) with the inclusion of additional additives. Such catalysts are typically prepared in sizes ranging from a few millimeters to much larger, and in various shapes and geometries. See H. F. Rase. Handbook of Commercial Catalysts, CRC Press (2000). Aside from the electronic structures, the overall catalytic performance is known to be largely influenced by the physical properties of the catalyst, such as, shape, size, geometry, porosity, and surface area of the powder. Hence, scaling a research catalyst for commercial applications becomes challenging, as the goal is to achieve a high catalytic performance by preserving or improving the active surface area and chemical and mechanical stability of the catalyst while minimizing pressure drop inside the reactor caused through increasing the extrudate mesh size. See, e.g., U.S. Pat. Pub. No. 2013/0224091; https://www.aimspress.com/article/doi/10.3934/environsci.2015.2.154. Thus, developing simple, yet high-throughput, processes for the large-scale synthesis of target catalytic materials with ideal properties has been critical to achieving high volumetric production of chemicals with high energy efficiency for a range of industrially relevant transformations with a direct impact on the overall manufacturing cost. Developing such a process is particularly important to the use of optically active photocatalytic materials in low-pressure-rated glass-based photoreactors for chemical bond activation by unconventional means, i.e., via the use of light, instead of heat from fossil-based resources.

Needed are improved preparations of photocatalyst extrudates for continuous-flow gas-phase fixed-bed photoreactors, such as those used to produce industrial chemicals and methods of production thereof.

### SUMMARY

One example set forth herein is directed to a method that includes co-precipitating solutions to form a photocatalyst slurry, centrifugating and drying the slurry to form a dried powder, mixing the dried powder with a binder and a porogen and combining with a solvent to form a dough, feeding the dough through an extruder to create extrudates having a predetermined shape and cross-section, drying the extrudate, and thermally treating the extrudate after drying. Various other example embodiments and alternatives are also presented herein, as are extrudate photocatalyst embodiments and photoreactor embodiments utilizing the extrudate photocatalyst embodiments described herein.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

The accompanying drawings are included to provide a further understanding of the systems, apparatus, devices, and/or methods of the disclosure, and are incorporated in and constitute a part of this specification. The drawings are not necessarily to scale, and sizes of various elements may be distorted for clarity and/or illustrated as simplistic representations to promote comprehension. The drawings illustrate one or more embodiments of the disclosure, and together with the description, serve to explain the principles and operation of the disclosure.

FIG. 1 is a photograph illustrating an extrudate photocatalyst support material with controlled shape and geometry for use in a photocatalytic reactor cell assembly, according to an example embodiment.

FIG. 2 is a photograph illustrating an extrudate photocatalyst support material with controlled shape and geometry for use in a photocatalytic reactor cell assembly, according to an example embodiment.

FIG. 3 is a photograph illustrating an extrudate photocatalyst support material with controlled shape and geometry for use in a photocatalytic reactor cell assembly, according to an example embodiment.

FIG. 4A is a flow diagram illustrating a first example method for producing extrudates, according to an example embodiment.

FIG. 4B is a flow diagram illustrating a second example method for producing extrudates, according to an example embodiment.

FIG. 5 is an isometric diagram illustrating a photocatalytic reactor cell assembly, according to an example embodiment.

FIG. 6 is a vertical cross-sectional diagram illustrating a photocatalytic reactor cell assembly, according to an example embodiment.

FIG. 7 is a horizontal cross-sectional diagram illustrating a photocatalytic reactor cell assembly, according to an example embodiment.

FIG. 8 is a vertical cross-sectional diagram illustrating a photocatalytic reactor cell assembly, according to an example embodiment.

FIG. 9 is an isometric diagram illustrating a photocatalytic reactor cell assembly with IR lamps, according to an example embodiment.

FIG. 10 is a vertical cross-sectional diagram illustrating a photocatalytic reactor cell assembly with IR lamps, according to an example embodiment.

FIG. 11 is a horizontal cross-sectional diagram illustrating a photocatalytic reactor cell assembly with IR lamps, according to an example embodiment.

### DETAILED DESCRIPTION

Example systems, apparatus, devices, and/or methods are described herein. It should be understood that the word “example” is used to mean “serving as an example, instance, or illustration.” Any embodiment or feature described herein as being an “example” is not necessarily to be construed as preferred or advantageous over other embodiments or features unless stated as such. Thus, other embodiments can be utilized, and other changes can be made, without departing from the scope of the subject matter presented herein. The aspects described herein are not limited to specific embodiments, apparatus, or configurations, and as such can, of course, vary. It should be readily understood that the aspects of the present disclosure, as generally described herein, and illustrated in the figures, can be arranged, substituted, combined, separated, and designed in a wide variety of different configurations. It is also to be understood that the terminology used herein is for the purpose of describing particular aspects only, and unless specifically defined herein, is not intended to be limiting.

Throughout this specification, unless the context requires otherwise, the words “comprise” and “include” and variations (e.g., “comprises,” “comprising,” “includes,” “including,” “has,” and “having”) will be understood to imply the inclusion of a stated component, feature, element, or step or group of components, features, elements, or steps, but not the exclusion of any other component, feature, element, or step or group of components, features, elements, or steps.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

As used in the specification and the appended claims, the singular forms “a,” “an,” and “the” include plural referents unless the context clearly dictates otherwise.

Ranges can be expressed herein as from “about” one particular value and/or to “about” another particular value. When such a range is expressed, another aspect includes from the one particular value and/or to the other particular value. Similarly, when values are expressed as approximations by use of the antecedent “about,” it will be understood that the particular value forms another aspect. It will be further understood that the endpoints of each of the ranges are significant both in relation to the other endpoint and independently of the other endpoint.

Any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. OVERVIEW

Effective, functional photocatalytic reactors are designed such that catalyst contacted with the reactant is illuminated by a photon source, thus driving the chemical reaction. Irradiation of light could be achieved by using natural (e.g., solar) or artificial sources of light (e.g., IR lamps, UV lamps, arc lamps, or light emitting diodes (LEDs)). Typical reactor configurations include slurry reactors, annular reactors, immersion reactors and optical fiber/tube reactors. See, e.g., Van Gerven et al., “A Review of Intensification of Photocatalytic Processes,” Chem. Eng. Process. Process Intensif., 2007, 46 (9 SPEC. ISS.), 781-789, https://doi.org/10.1016/j.cep.2007.05.012, the entirety of which is incorporated by reference herein. Challenges to process intensification of these reactors mainly arise from photon and mass transfer limitations. Research into photocatalytic reactors for the conversion of gaseous species is still in its infancy, and the present applicants are not aware of any reported examples of a successful scale-up of a laboratory set-up to an industrially relevant scale. Difficulties in reactor design, material selection, and an incomplete understanding of the critical parameters that are important to reactor design have hampered past development efforts. See, e.g., de Lasa et al., “Photocatalytic Reaction Engineering,” Springer, Boston, MA, 2005, https://doi.org/10.1007/0-387-27591-6.

Several large-scale photocatalytic reactors have been proposed, and of these designs, slurry reactors, annular reactors, immersion reactors, and optical tube reactors have been tested in the area of wastewater treatment, for liquid state reactions only. See, e.g., de Lasa et al., “Photocatalytic Reaction Engineering,” Springer, Boston, MA, 2005. The light source in such reactors is oriented such that it illuminates the longitudinal axis of the reactors to drive the photocatalytic treatment of wastewater. The catalyst in the reactor is either fluidized by the wastewater or immobilized by support material. Commonly reported drawbacks associated with these types of reactors center around the lack of uniform irradiance of the photocatalyst and mass transfer limitations associated with insufficient contact between the photocatalyst and the fluid. Strategies to improve mixing and overcome mass transfer limitations include the use of rotors and/or impellers in the reactor to create turbulent fluid flow. See, e.g., U.S. Patent Application Publication No. US20130008857A1. More recently, photocatalytic reactors are being used for the removal of volatile organic components as part of air purification modules. See, e.g., U.S. Patent Application Publication No. US20210023255A1. These reactor designs incorporate “fins” or directional blades to improve mass transfer and contacting of the air with the coated photocatalyst.

Implementation of these processes at a larger scale than that studied in research and development settings has been stymied for a variety of reasons. Photocatalytic reactor development has not had the decades of experience associated with thermal catalytic reactors. A sound understanding of the fundamental processes underlying thermal catalytic reactors simplifies the scaleup of a lab-scale thermal catalytic reactor process to the pilot scale and beyond. Thermal catalytic reactors also benefit from proven numerical and kinetic modeling. Conversely, investigations into photocatalytic and photo-thermal catalytic processes have instead focused on understanding product formation and reaction kinetics, as well as obtaining a mechanistic understanding of the underlying chemistry. The inclusion of photons in photocatalysis causes significant deviations in reactor performance from traditional thermal catalytic reactors. Added complexities include the selection of suitable light sources and reactor geometries (which affects photon behavior and catalytic performance of the process). These unknowns add significant variability to scale-up and process intensification. See, e.g., Pasquali et al., “Radiative Transfer in Photocatalytic Systems,” AIChE J., 1996, 42 (2), 532-537, https://doi.org/10.1002/aic.690420222, and Alfano et al., “Photocatalysis in Water Environments Using Artificial and Solar Light,” 2000; Vol. 58, https://doi.org/10.1016/S0920-5861 (00) 00252-2, both of which are incorporated by reference herein.

Other complexities have contributed to the relatively slow development of photocatalytic reactor designs. See, e.g., Su et al., “Photochemical Transformations Accelerated in Continuous-Flow Reactors: Basic Concepts and Applications,” Chem.—A Eur. J., 2014, 20 (34), 10562-10589. https://doi.org/10.1002/chem.201400283, the entirety of which is incorporated by reference herein. One such consideration includes the choice of material for reactor cell construction, as photocatalytic processes require transparent windows for light or photons to irradiate the catalyst. Reactor geometries should also be optimized for photon transport such that light losses are minimized and photon flux is concentrated toward the catalyst bed. A photocatalytic reactor cell design should also be able to facilitate gas-solid mixing and transport characteristics to promote optimal catalytic performance. Fabrication of stainless steel and glass-based pilot-scale photocatalytic reactors within design specifications is an engineering challenge that has been an obstacle to further development. Inclusion of reflective materials, control electronics for photon sources, and auxiliary processes to support photocatalytic reactor functions have added considerable complexity to the development of photocatalytic reactors.

Another consideration that has contributed to the slow development of photocatalytic reactor designs is choosing optimal aggregate or extrudate photocatalytic support material for a photocatalyst filled bed, such that high-pressure gas reactants are allowed to flow through the photocatalyst packed bed. Optimization of such aggregate or extrudate photocatalytic support material includes providing controlled shape and geometry of such aggregate or extrudate photocatalytic support material. Without such optimized support material, the pressure can cause the quartz reactor cells to break.

To address some of the shortcomings of prior photocatalytic reactors, disclosed herein are embodiments of optimized support material comprising extruded photocatalyst for applications in a quartz based photoreactor for use in industrial chemical production.

Such optimized extrudate photocatalytic support materials can be used in various reactor cell assemblies for continuous-flow photocatalysis of gaseous species for industrial chemical production, including those set forth in PCT/US2022/031444, the entirety of which is incorporated by reference herein. The disclosed reactor cell embodiments include example reactor cells capable of performing chemical reactions with gaseous feed using incident photons (i.e., light) over a packed bed of photocatalyst placed in the annulus of a reactor cell having outer and inner cell walls. In some example embodiments, one or both of the outer and inner cell walls are transparent. Other reactor cell embodiments are also described herein.

Example embodiments set forth herein are generally directed to a photocatalytic reactor cell that is annular in nature, with a supported nanoparticle photocatalyst packed bed. The annular region may be made of materials transparent in the visible and near IR region. The gaseous reactants flow through the packed photocatalyst bed similar to as in a plug-flow reactor, allowing for continuous reaction and generation of the desired product. The energy to the photocatalyst may be provided on one or both sides (i.e., exterior and/or interior) of the annular region via a light housing having many photon emitters, such as Light Emitting Diodes (LEDs) or IR lamps, mounted on or serving as portions of the light housing, for example. The specific geometry and use of transparent or reflective or scattering materials allows for an efficient way of transmitting light energy to the photocatalyst, to promote efficient chemical reactions. In some embodiments, the light housing may include a cooling assembly to assist in cooling the photon emitters and/or surfaces on which the photon emitters are mounted. In some other embodiments, one or more heaters may be included to increase the photocatalytic reaction rate. Other shaped-reactors besides annular reactors are also intended to be within the scope of various embodiments of the claimed invention.

Some embodiments set forth herein allow for reduced dependency on fossil fuels and reduced carbon emissions. For example, embodiments may utilize electricity for activation of the photon emitters (e.g., LEDs). Such electricity may be generated using renewable resources, such as solar-, hydro-, or wind-generated power. As a result, environmental benefits may be realized for industrial chemical reactions that have conventionally been performed via thermal catalysis using heat energy generated by burning of fossil fuels.

The chemical reactions that can be performed in various embodiments of the reactor cells described herein conventionally require very high temperatures due to high enthalpy of reaction. Conventional thermal catalytic reactors are typically made of relatively expensive materials that can sustain such high temperatures. In addition, conventional thermal catalytic reactors are typically imparted with heat energy in an inefficient and environmentally unfriendly manner via burning of fossil fuels. Conversely, various reactor cell embodiments described herein can assist in performing these same chemical reactions in the presence of visible light at much lower temperatures than required for conventional thermal catalytic reactors. This enables the use of relatively inexpensive materials, such as glass, for the construction of the reactor. Additionally, the accompanying lower operating temperatures may prolong the lifespan of reactor components for the example photocatalytic reactors described herein.

The various photoreactor cell assembly and photocatalyst embodiments set forth herein may serve as a platform technology allowing for multiple gas-phase chemical reactions requiring high enthalpy of reaction and high activation energy via the use of light energy. For example, the following is a non-exclusive list of reactions and reaction types possible using one or more example embodiments set forth herein:
1. Steam methane reforming.
2. Dry methane reforming.
3. Partial oxidation of methane.
4. Autothermal reforming.
5. Decomposition of ammonia.
6. Ammonia synthesis.
7. Water gas shift reactions.
8. Reverse water gas shift reactions.
9. CO₂ hydrogenation.
10. Reforming of heavier hydrocarbons (e.g., alkylated cyclics, resins and asphaltenes).
11. Fischer-Tropsch synthesis.
12. Methanol synthesis.
13. Ethanol synthesis.
14. Hydrogenation to make saturated compounds.
15. Dehydrogenation to make ethylene and propylene.
16. Epoxidation reaction.
17. Breaking of carbon-halogen bonds, such C—F, C—Cl, C—I, and C—Br.

### II. EXTRUDATE CATALYSTS OPTIMIZED FOR USE IN GLASS-BASED PHOTOREACTORS

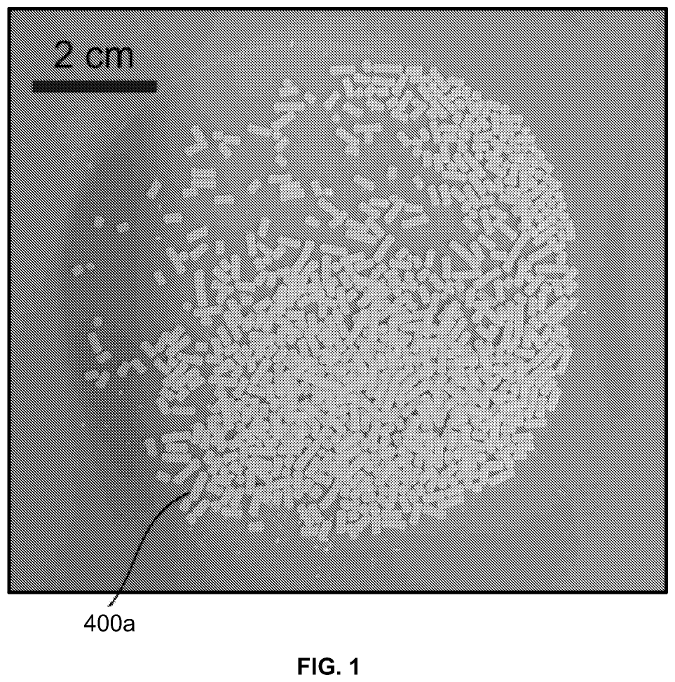

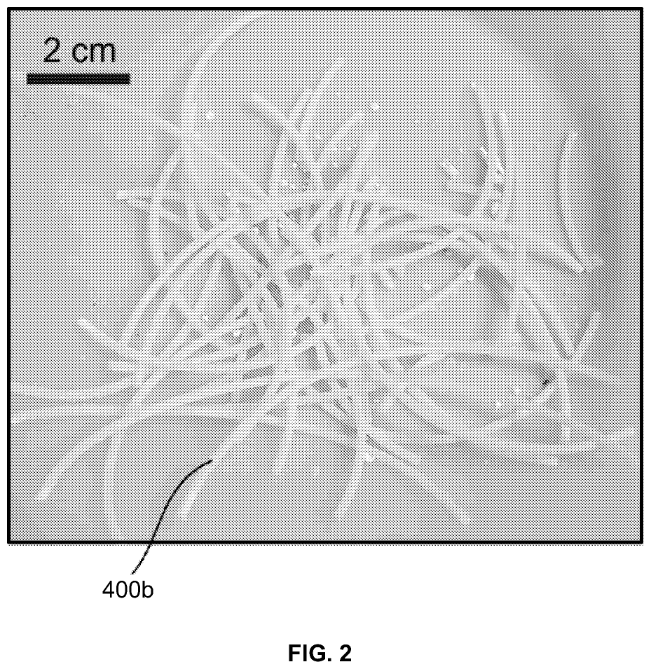

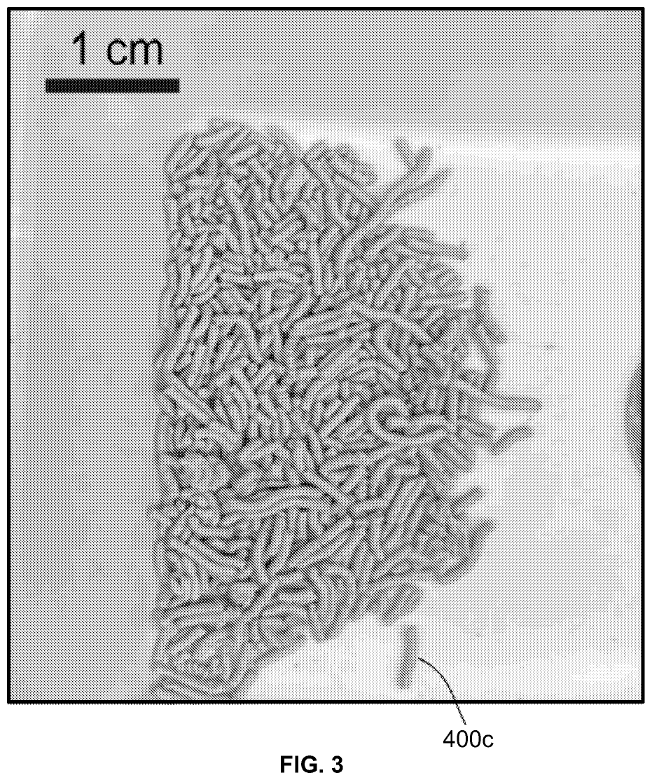

FIG. 1 illustrates a photocatalyst support material 400a with controlled shape and geometry for use in a continuous-flow gas-phase photocatalytic reactor cell assembly, according to a first example embodiment. FIG. 2 illustrates a photocatalyst support material 400b with controlled shape and geometry for use in a photocatalytic reactor cell assembly, according to a second example embodiment. FIG. 3 illustrates a photocatalyst support material 400c with controlled shape and geometry for use in a photocatalytic reactor cell assembly, according to a third example embodiment. Each of FIGS. 1, 2, and 3 includes a scale (1 cm or 2 cm) to show catalyst extrudate size (thickness and length) for the illustrated examples.

### A. Example Methods for Producing Extrudate Photocatalyst Support Material

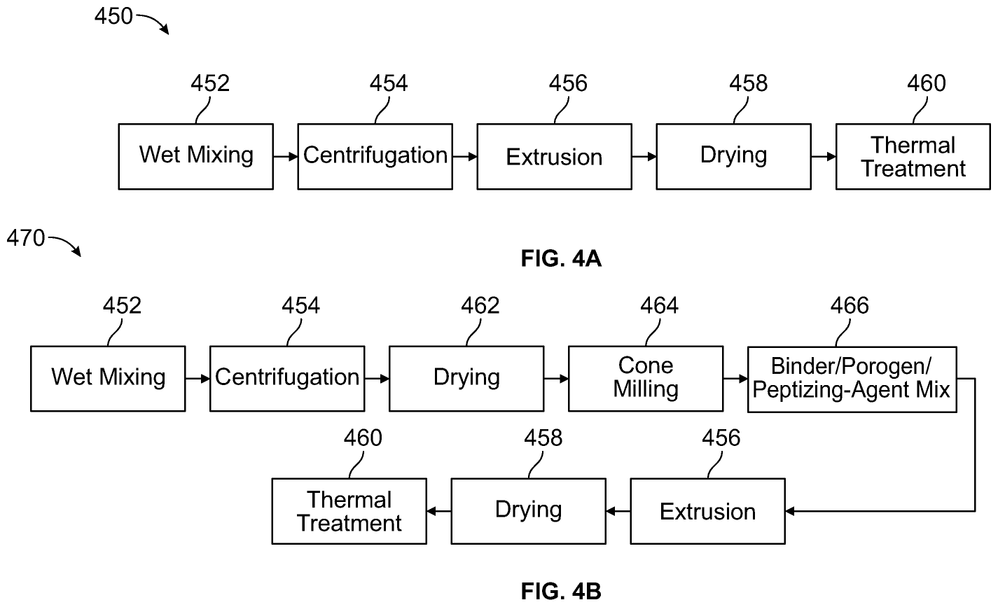

The photocatalyst support materials 400a, 400b, and 400c illustrated in FIGS. 1-3 are produced according to a method for extrudate photocatalyst support material, such as via one of the example methods 450 or 470 illustrated in the respective flow charts of FIGS. 4A and 4B, or variations thereof, as described below. The second example method 470 differs from the first example method 450 in that the second example method 470 includes up to three additional steps after centrifugation: a paste drying step 462, a milling step 464, and a binder/porogen/peptizing agent mixing step 466. The first example method 450 is described first below, followed the second example method 470. Common steps of each of the two example methods are similarly numbered.

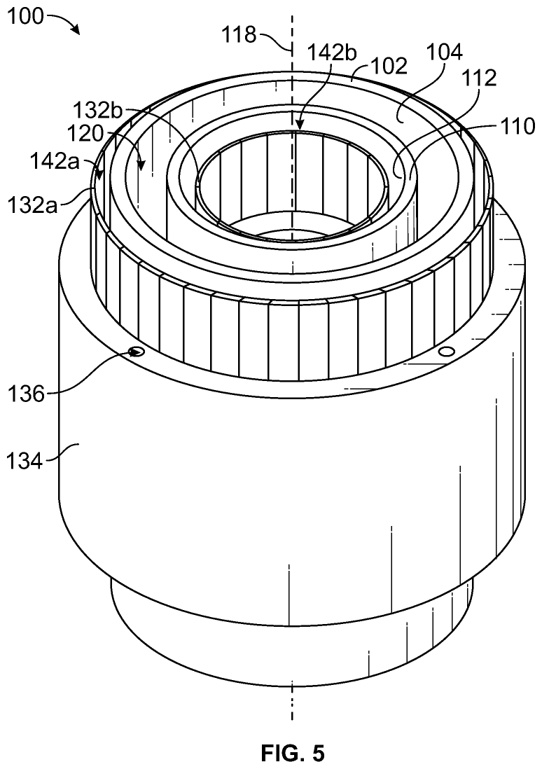

The first example method 450 includes co-precipitating two solutions to deposit active metals on a selected support (see description accompanying FIGS. 5-8, below), as shown in “wet mixing” block 452. The aged co-precipitated slurry from the wet mixing block 452 is then separated and washed through centrifugation until almost all or substantially all traces of unreacted chemicals, byproducts, and solvents are removed, as shown in “centrifugation” block 454.

Next, in the first example method 450, the resulting paste from the centrifugation wet cake is subjected to extrusion, as shown in “extrusion” block 456. Analysis of the solvent content of the paste after centrifugation and prior to extrusion can help to determine the degree of extrudability, which may indicate further centrifugation is needed for better extrudate strength, for example. For the first example method 450, a preferred solvent content may be in the range of 40 to 60 mass percent; a solvent content outside this range may indicate that the centrifugation duration should be adjusted (less time to increase solvent content or more time to decrease solvent content).

In the “extrusion” block 456, the paste resulting after centrifugation is fed to an extruder to make spaghetti-shaped extrudates (in some embodiments) through a die having multiple holes. The length of the extrudates can be selected by cutting the output extrudates to desired lengths using a cutter, for example. The diameter (or other cross-sectional dimension) of the extrudates is controlled by selecting a corresponding size of the holes in the die. The cross-sectional shape of the extrudates is controlled by selecting a corresponding shape of the holes in the die. Different shapes of extrudate, including, but not limited to, cylinders, cloverleaf, dumbbell, symmetrical and asymmetrical polylobate and so forth, are possible and are intended to be within the scope of this application. A single die may have more than one size or shape of hole, in some example embodiments, resulting in extrudates of more than one size or shape. In addition, in some example embodiments, the extrudates may be further shaped to another desired form, such as spheres, by using a spheronizer, for example.

The length-to-diameter (L/D) ratio of the extrudates may have a significant impact on packing (and, hence, interparticle porosity, as discussed further below) of the extrudate photocatalyst within a photoreactor. In some example embodiments, the L/D ratio is in the range of 1 (spherical extrudates) to 10. Assuming the smallest dimension of extrudates is 1 mm in size, then the largest dimension would be 1 cm. In alternative embodiments, the L/D ratio is 100 or 1000 (10-100 cm extrudate length for a smallest dimension of 1 mm), which could be advantageous in the case where extruded photocatalyst is in the form of a large monolith to be used with a photoreactor. For the example embodiments set forth herein, an extruded photocatalyst having larger than 1 mm size (i.e., smallest dimension, such as diameter or thickness or length) may be preferable to provide advantageous pressure drop characteristics in a photoreactor.

Continuing with the first example method 450, the extrudate is allowed to dry for several hours in an oven, as shown in “drying” block 458. Then, the extrudate catalyst is subjected to thermal treatment in air/inert or reducing environment, as shown in “thermal treatment” block 460, in order to develop desired properties and/or phase structures for the intended application (e.g., photocatalysis). In some example embodiments, calcination of extrudates can be conducted in the presence of air at a temperature range of 150-800° C. for several hours and the reduction of extrudates can be conducted in the presence of hydrogen at temperature range of 150-800° C. (or higher) for desired amount of time (typically several hours). According to the above-described examples, the reduced catalyst has an average surface area that is typically about 100 m²/g, but could be as high as 130 m²/g or even higher, depending on material properties, manufacturing process, and conditions used for the catalyst treatment.

The second example method 470 includes most or all of the same steps/functions described above with respect to the following blocks for the first example method 450: “wet mixing” 452, “centrifugation” 454, “extrusion” 456, “drying” 458, and “thermal treatment” 460. However, the second example method 470 introduces the additional steps/functions of (a) drying, (b) milling, and (c) mixing with binder, a porogen, and, in some cases, a peptizing agent. These additional steps of the second example method 470 are performed after the “centrifugation” block 454 and before the “extrusion” block 456. Each of these additional steps is now described in turn.

The second example method 470 can improve the extrusion process (block 456), with stronger extrudates and other potential benefits, compared to the first example method 450. In general, the extrusion process should be performed at a solvent content that is slightly higher than a capillary state. If the solvent content is lower or higher, this may cause the dough to change its liquid bridging state to a funicular or droplet state, where extrusion processing becomes difficult. In particular, the desirable crushing strength of the extrudates may be adversely affected. See Winstone, G. (2011). Production of Catalyst Supports by Twin Screw Extrusion of Pastes [EngD thesis, University of Birmingham]. University of Birmingham Research Archive. [https://etheses.bham.ac.uk/id/eprint/5706/1/Winstone11EngD.pdf]. The second example method 470 avoids some of the potential difficulties of the first example method in controlling the liquid state of the dough or paste before extrusion. Namely, in this second example method 470, firstly the first centrifugation wet cake is dried to remove physiosorbed water, secondly dried powder is cone-milled to obtain homogeneous powder particles (e.g., greater than 120 μm), thirdly all dried powders (catalyst powder, organic binder and porogen) are mixed and solvent is added to convert into dough for the extrusion process (block 456).

Thus, in the second example method 470, the resulting paste after centrifugation from the “centrifugation” block 454 is dried to further remove remaining solvent from the paste, as shown in the “drying” block 462. This drying of the paste in the “drying block” 462 results in production of a dried powder. This dried powder can be further processed through milling, such as via cone milling, as shown in the “cone milling” block 464. Milling of the dried powder helps to produce a relatively homogeneous size of the catalyst particles in the milled dried powder. Then, the homogeneous dried catalyst powder is mixed with a binder and a porogen material and, in some cases, a peptizing agent is added (see below for examples of each), as shown in the “binder/porogen/peptizing agent mixing” block 466. An organic binder, rather than an inorganic binder, may be used to (1) enhance the number of active sites present in the final photocatalyst extrudates and (2) help create more porosity in final photocatalyst extrudates, due to the organic binder decomposing. The mixing may be via a commercial mixer, for example, such as a Hobart™ commercial kitchen mixer. Upon addition of solvent to the mixture, this “binder/porogen/peptizing agent mixing” step 466 results in a dough that is fed to the extruder described above with respect to the “extrusion” block. While in the first example method 450 the resulting paste after centrifugation is fed to the extruder, in the second example method, the above-described dough is fed to the extruder. Controlling the amount of solvent and peptizing agent helps to determine the physical properties (e.g., crushing strength and porosity) in the second example method 470. The solvent helps during with miscibility of solid particles and to form the dough for the extrusion process. In some cases, a peptizing agent (e.g., diluted acid solution) is also used, which enhances dispersion of a solid into a colloidal form by precipitating. The “extrusion” block 456, “drying” block 458, and “thermal treatment” block 460 are otherwise the same or similar for both the first example method 450 and the second example method 470.

The second example method 470 utilizes a formulation of appropriate binder, porogen, and solvent concentrations to provide one or more of at least the following technical benefits: (1) a relatively lower pressure drop (e.g., 95% pressure drop improvement compared to a comparable photocatalyst, as discussed below) across the photocatalyst bed in a photoreactor when compared to powder photocatalyst particles, (2) a relatively higher mechanical strength of extrudates to improve crushing strength (e.g., greater than 10 N/mm²) with only a possible slight performance loss (e.g., 8%), and (3) an ability to re-use photocatalyst for several photocatalysis cycles without its losing its effective structure (less compaction and associated less pressure drop due to improved crushing strength). An example ratio of catalyst powder to binder to porogen is in the range of 98:1:1 to 75:20:5. An example ratio of solid (e.g., mixed catalyst/binder/porogen/peptizing agent powders) to solvent is in the range of 2:1 to 1:2.

The following is particular implementation of a procedure for making photocatalyst support extrudates in accordance with the second example method 470:
1. Weigh required amount of catalyst powder (>120 mesh size), binder, and porogen.
2. Place the catalyst powder, binder, and porogen in blender pan. Mix all solids for about 15 minutes with RPM of 100 to create homogeneous mixture.
3. Weigh required amount of solvent (e.g., water or diluted acid, typical range of solid to solvent ratio 1) and place in a beaker.
4. Slowly add the required amount of solvent (water, diluted acid, etc.) to the solid mixture under stirring conditions.
5. After adding the solvent, thoroughly mix the dough in the blender pan for about 20 minutes to form a thickened wet dough material for extrusion.
6. Prepare the extruder, e.g., by assembling the screw extruder attachment and mounting the product collection tray and any safety guards.
7. Push the thickened wet dough material into the extruder feed such as by using a feeder scraper to guide the dough through the extruder auger tube and into a die having holes of desired shape and diameter/width (e.g., circular holes of 1.6 mm in diameter resulting in a cylindrical extrudate of similar diameter).
8. Cut the extrudates with a cutter to achieve a desired diameter-to-length aspect ratio (e.g., aspect ratio of between 1 and 10).
9. Dry the cut extrudates in a dryer.
10. Apply a thermal treatment suited to a particular application for the photocatalyst extrudates.

The above implementation is merely an example; different equipment and/or different values for catalyst powder mesh size, mixing times, mixing RPM, mixing ratios, die hole diameter/width and/or shape, and other parameters could be used in other implementations.

### B. Porosity of Example Photocatalyst Support Materials

Porosity of a catalyst, including the extrudate photocatalysts illustrated herein, can be split into inter and intra porosity. Interparticle porosity is the void space between catalyst particles, while intraparticle porosity is the void space within each particle. In general, the porosity of a catalyst is defined by the following equation:

$$ε = \frac{{V}_{V}}{{V}_{T}} = \frac{{V}_{intra} + {V}_{inter}}{{V}_{T}} \qquad Equation 1$$

Here V_{V} is the volume of void space (split into intra and inter void space) and V_{T} is the volume of catalyst particle. The catalyst pore volume (ml/g) can be measured through BET analysis giving us Vᵢₙₜᵣₐ for a certain mass of catalyst. The total porosity can be found by fitting the Ergun equation:

$$Δ P = \frac{150 μ L}{{D}_{p}^{2}} \cdot \frac{{( 1 - ε )}^{2}}{{ε}^{3}} {v}_{s} + \frac{1.75 ρ L}{{D}_{p}} \cdot \frac{( 1 - ε )}{{ε}^{3}} {v}_{s}^{2} \qquad Equation 2$$

where ΔP is the pressure drop (psi), Dₚ is the average particle diameter (m), vₛ is the superficial velocity (m/s), ρ is the density of fluid (kg/m³), and L is the length of the catalyst bed. Experiments were run at separate flowrates for extrudates produced in accordance with example embodiments and the pressure drop data was fit to this equation. The porosity ranged from 0.3-0.45 for the different extrudate catalyst tested.

### C. Properties of Example Photocatalyst Support Materials

The extrudate photocatalyst support material embodiments illustrated in FIGS. 1-3 (and other embodiments illustrated and described herein), can be produced via methods such as the methods 450 and 470 illustrated in FIGS. 4A and 4B. In some embodiments, the extrudate photocatalyst support materials illustrated in FIGS. 1-3 comprise metal-based photocatalytic materials (i.e., plasmonic photocatalysts) and have a generally cylindrical shape (perhaps curved) and controlled geometry (400a, 400b, 400c) with high porosity. When produced according to example embodiments set forth herein, the optical properties of the extrudate photocatalysts can be preserved during manufacturing and the extrusion process, such that the optical absorption spectrum of a given extrudate is similar to that of the same catalyst in pristine fine powder form. In some embodiments, preservation of the optical properties of the catalyst (i.e., photocatalyst) is achieved by using water as the solvent and/or the binder to exclude the use of additional additives or binders that can otherwise compromise the optical properties of the catalyst, while also impacting other parameters of the catalyst, such as density, porosity, strength, etc.

In some embodiments, producing an optimized extrudate shape and geometry comprises (1) designing the photoreactor to maximize light harvested by the catalyst and minimize photon loss from the photoreactor (described in further detail below with respect to FIGS. 5-8); (2) maximizing the exposed active surface area of the photocatalyst for interaction with adsorbate molecules (i.e., mesoporous photocatalyst with a high surface area); (3) minimizing the pressure drop inside the photoreactor; and (4) improving the crush strength of the photocatalyst to reduce erosion over time in the photoreactor. Regarding the fourth point, reduced erosion can avoid increased pressure drop across the packed bed and can also avoid plugs downstream of the photoreactor.

In some embodiments, production of an extrudate photocatalyst using the methods 450 or 470 shown respectively in FIGS. 4A and 4B enables reducing the pressure drop from the catalyst bed. For larger scale reactors, the flow rates necessary to achieve the desired daily production (e.g., 200 kg/day or more) cause a large pressure drop through the catalyst. In the embodiments described herein, the relatively larger particle size with relatively optimized mesoporosity of the extrudate alleviates this pressure drop significantly by increasing overall porosity of the packed bed. Further, decreasing the pressure drop within the photoreactor cells allows for the removal or downsizing of energy intensive components like compressors downstream of the reactor. This can increase the efficiency of the overall photoreactor system as it requires less energy input. In such embodiments, these features allow for increased photocatalytic performance and volumetric production capacity of a photoreactor as compared to other photocatalytic reactors.

In some embodiments, to modify or supplement the example methods 450 and 470, binders such as guar gum, alumina, silica, silica-alumina, titania, zirconia, or natural clay can be used to increase mechanical strength of an extruded catalyst. In some embodiments, the binder can be added to the catalyst powder after drying to prepare a paste for extrusion. In some embodiments, a porogen, such as starches of different sizes, flax, or carbon black can be used to increase intraparticle porosity of a catalyst. The porogen can be removed during the drying process via thermal decomposition, for example. In some embodiments, a lubricant, such as a viscose liquid or peptizing agent can be added to the catalyst mix to reduce friction during the process of shaping a catalyst. In some embodiments, modifiers, such as metal oxide promoters, can be used prior to extrusion to enhance the performance of a photocatalyst. In some embodiments, different extrudate shapes are possible, as stated above. The shape and size of the particles greatly affect pressure drop as provided in Equation 2 above. The example materials described immediately above may be utilized as the binder, porogen, and/or peptizing agent described above with respect to block 466 of the second example method shown in FIG. 4B.

### III. PRESSURE LIMITATIONS FOR GLASS CYLINDERS AND GLASS BASED PHOTOREACTORS

To prevent breakage of glass-based photoreactors such as those described herein, an understanding of the pressure limitations for glass cylinders used in photoreactors and ways to prevent breakage and to scale up the size and output of such photoreactors is helpful. Accordingly, for a fused quartz cell, the major stress experienced by the photoreactor cell is the hoop or radial stress. This stress can be defined for a thin wall as:

$${σ}_{h} = \frac{{P}_{int} {D}_{i}}{2 t} \qquad Equation 3$$

Where σₕ is the hoop stress (psi), Pᵢₙₜ is the internal pressure (psi), Dᵢ is the inner diameter of the cell (m), and t is the thickness of the cell (m). Reasonable maximum hoop stress is known to be 7000 psi. With a safety factor of 7, we use 1000 psi as the maximum allowable hoop stress. Rearranging (3) gives an equation for the minimum thickness required for the cell to meet this hoop stress limit:

$${t}_{min} = \frac{{P}_{int} {D}_{i}}{2000 [ psi ]} \qquad Equation 4$$

Further, the maximum internal pressure that a photoreactor cell can handle is calculated as follows:

$${P}_{max} = \frac{2000 [ psi ] t}{{D}_{i}} \qquad Equation 5$$

In some embodiments, for example, a reactor has an outer diameter of 142.7 mm and a thickness of 6.35 mm. Substituting these numbers into equation 5 above gives a maximum internal pressure of about 97 psi for the example reactor. However, the described example reactor has been found to experience a maximum internal pressure of about 20-25 psi, which is well below the threshold. In some embodiments, for scaling up a reactor to a desired 200 kg, for example, the selected fused quartz cells will have a thick wall (as opposed to a thin wall) and, accordingly, a different stress equation is used to determine the maximum internal pressure:

$${σ}_{h} = \frac{{P}_{int} ( {D}_{o}^{2} + {D}_{i}^{2} )}{{D}_{o}^{2} - {D}_{i}^{2}} \qquad Equation 6$$

Here Dᵢ is the inner diameter of the cell (m). Using the same safety factor, a similar relationship for the maximum allowed internal pressure can be determined as follows:

$${P}_{int} = \frac{1000 [ psi ] ( {D}_{o}^{2} - {D}_{i}^{2} )}{{D}_{o}^{2} + {D}_{i}^{2}} \qquad Equation 7$$

In this example embodiment, the larger fused quartz cells have an outer diameter of 332 mm and an inner diameter of 290. This gives a maximum internal pressure of 134 psi. Calculating worst case scenario tolerances, the maximum internal pressure drops to 121 psi. With a typical catalyst size of 375 μm, the pressure drop ranges from 85 psi to 150 psi based on the length of the catalyst bed. These results demonstrate a need for a larger mesoporous catalyst that will lower the pressure drop across the catalyst bed.

### IV. REACTOR CELL ASSEMBLIES FOR PHOTOCATALYSIS OF GASEOUS SPECIES

To better illustrate how the above-described example extruded photocatalyst support materials may be utilized in a photoreactor, two example photocatalytic reactor cell assemblies each having an annular cross section are shown and described in FIGS. 5-8 and FIGS. 9-11, respectively. In addition to describing the positioning of the photocatalyst within the photoreactor, FIGS. 5-11 illustrate other components that may advantageously be included to allow for efficient photocatalytic industrial chemical production. These features include cooling mechanisms, sealing mechanisms, and integrated light sources, referred to as “photon emitters” in the following discussion. The photocatalyst support extrudates described herein may be used with other photoreactor designs and configurations besides the example annular reactor cell shown in FIGS. 5-8 and 9-11. For example, the photocatalyst support extrudates may be utilized with cylindrical reactor cells or reactor cells having a regular polygonal cross-section. As another example, the reactor cell may have an annular cross section (i.e., two coaxially arranged cylinders of different diameters) similar to as described with respect to FIGS. 5-8 and 9-11, but with only an inner light housing (e.g., an inner IR light housing) and no outer light housing. Alternatively, the reactor cell may be annular with an outer light housing and no inner light housing. The following discussion merely illustrates two examples out of many in which the photocatalyst support extrudates set forth herein may be utilized.

### A. Reactor Cell Assembly Having Cooled Outer and Inner LED Light Housing

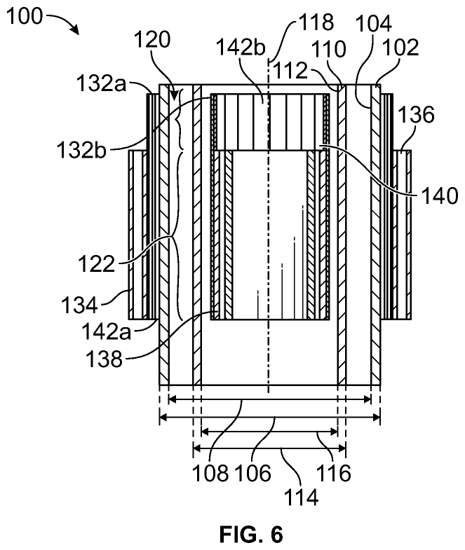

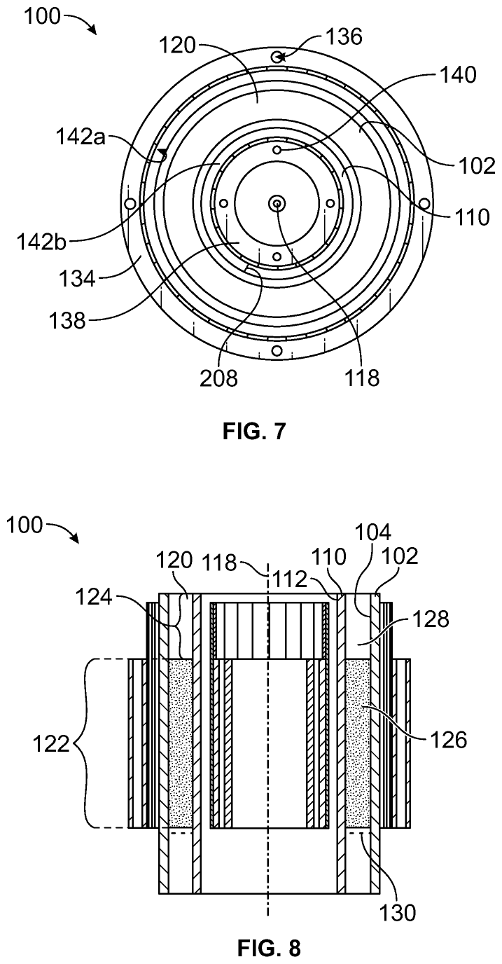

FIG. 5 is an isometric diagram illustrating a photocatalytic reactor cell assembly 100, according to a first example embodiment. FIG. 6 is a vertical cross-sectional diagram illustrating the photocatalytic reactor cell assembly 100, according to the first example embodiment. FIG. 7 is a horizontal cross-sectional diagram illustrating the photocatalytic reactor cell assembly 100, according to the first example embodiment. FIG. 8 is a vertical cross-sectional diagram illustrating the photocatalytic reactor cell assembly 100 with installed photocatalyst, according to the first example embodiment. The following description of the first example embodiment references features and components shown in one or more of FIGS. 5-8, where like reference numerals refer to like features and components. As with all figures referenced herein, one or more of FIGS. 5-8 may omit some features and/or components, as appropriate, to permit better illustration and comprehension.

As illustrated, the photocatalytic reactor cell assembly 100 includes an outer cell wall 102 comprising a first tube 104 having a first outer diameter 106 and a first inner diameter 108. The photocatalytic reactor cell assembly 100 also includes an inner cell wall 110 comprising a second tube 112 having a second outer diameter 114 and a second inner diameter 116, where the second outer diameter 114 is smaller than the first inner diameter 108. The outer cell wall 102 and the inner cell wall 110 are arranged concentrically about a vertical axis 118 to define an annular volume 120 between the outer cell wall 102 and the inner cell wall 110.

In the example of FIGS. 5-8 (and other embodiments illustrated herein), the first tube 104 and the second tube 112 are cylindrical, with a circular cross section. In other embodiments, the first tube 104 and/or the second tube 112 may have a shape that is non-cylindrical. For example, one or both of the first tube 104 or the second tube 112 may be constructed of tubing having a square, hexagonal, octagonal, or other regular polygonal cross-section. For embodiments utilizing non-circular cross sections for the first tube 104 and/or the second tube 112, the term “diameter” is intended to refer to a perpendicular distance between the vertical axis 118 and a side (or corner) of the first tube 104 and/or the second tube 112, and the term “annular volume” is intended to refer to the regular-shaped volume between the outer cell wall 102 and the inner cell wall 110. Moreover, the first outer diameter 106 and/or the first inner diameter 108 of the first tube 104 may vary over the height (length) of the first tube 104, such as may be the case if a middle portion of the first tube 104 is wider than end portions. Similarly, the second outer diameter 114 and second inner diameter 116 of the second tube 112 may vary over the height (length) of the second tube 112. For example, the first tube 104 and/or the second tube 112 may have two or more cylindrical portions of differing diameters, with each of the cylindrical portions being joined end-to-end via angular connecting portions that serve as size-adapters between the different cylindrical portions.

For the embodiment illustrated in FIGS. 5-8, at least portions of both the outer cell wall 102 and the inner cell wall 110 are constructed of a material that is transparent to photons emitted by photon emitters (described in further detail below). For example, the outer cell wall 102 and the inner cell wall 110 may be constructed of a material that is transparent to photons in the visible light spectrum. As another example, the outer cell wall 102 and the inner cell wall 110 may be constructed of a material that is transparent to photons in the near-infrared (near-IR) spectrum. As such, the outer cell wall 102 and/or the inner cell wall 110 may be constructed of one or more of the following, without limitation: glass, fused quartz glass, borosilicate glass, or a metallic material. As another alternative, the outer cell wall 102 and/or the inner cell wall 110 may be constructed of a transparent ceramic material, such as one of the materials described in Kachaev, A. A., Grashchenkov, D. V., Lebedeva, Y. E. et al. Optically Transparent Ceramic (Review). Glass Ceram 73, 117-123 (2016). https://doi.org/10.1007/s10717-016-9838-3.

As shown in FIGS. 6 and 8, the annular volume 120 between the outer cell wall 102 and the inner cell wall 110 may include two or more portions along its height (length), including a middle portion 122 and an upper portion 124. The middle portion may be filled with a photocatalyst packed bed 126, as shown in FIG. 8, while the upper portion 124 may serve as a headspace 128 to allow for reactant gas mixing. The upper portion 124 may be empty, as shown in FIG. 8, or it may be occupied, at least partially, by a gas mixing material, such as quartz wool, SiC, or beads (e.g., alumina beads and/or silica beads).

The photocatalyst packed bed 126 is positioned in the annular volume 120 between the outer cell wall 102 and the inner cell wall 110. The photocatalyst packed bed 126 has a photocatalyst on a support material. For example, the photocatalyst packed bed 126 may include a photocatalyst co-precipitated with a support material (see “wet mixing” block 452 in FIGS. 4A and 4B). The photocatalyst may comprise antenna-reactor plasmonic nanoparticles, for example. Various antenna-reactor catalysts developed by Rice University are described in U.S. Pat. No. 10,766,024 (incorporated by reference herein) and can effectively utilize light energy to perform various chemical reactions. For example, such antenna-reactor catalysts can be used in the reactor cell embodiments described herein to provide high conversion at high space velocity, resulting in a high hydrogen production rate per unit volume of catalyst bed. Depending on the type of chemical reaction to be performed, an appropriate antenna-reactor catalyst can be matched with correspondingly appropriate LED diodes to efficiently activate the photocatalyst, thereby resulting in high reaction rates. For example, in the case of Photocatalytic Steam Methane Reformation (PSMR), a high reaction rate equivalent to 270 micromoles/g/s has been achieved using an appropriate photocatalyst in reactor cell embodiments described herein.

In some embodiments, only a portion of the outer cell wall 102 and/or the inner cell wall 110 is transparent to photons. This transparent portion of the outer cell wall 102 and/or the inner cell wall 110 may correspond to the middle portion 122 of the annular volume 120 illustrated in FIGS. 6 and 8, such that the transparent portion of the outer cell wall 102 and/or the inner cell wall 110 is directly adjacent to the photocatalyst packed bed 126. For example, in one embodiment, at least a first portion of at least one of the outer cell wall 102 and the inner cell wall 110 is constructed of a material that is transparent to the photons emitted by the photon emitters, while at least a second portion of at least one of the outer cell wall 102 and the inner cell wall 110 includes one or more reflective surfaces to reflect any emitted wayward photons into the photocatalyst packed bed 126. In another example embodiment, at least a first portion of at least one of the outer cell wall 102 and the inner cell wall 110 is constructed of a material that is transparent to the photons emitted by the photon emitters, while at least a second portion of at least one of the outer cell wall 102 and the inner cell wall 110 includes one or more scattering surfaces to scatter any emitted wayward photons into the photocatalyst packed bed 126. The “second portion” referenced in each of the previous two described embodiments may correspond to the upper portion 124 of the annular volume 120 illustrated in FIGS. 6 and 8, such that the second portion is directly adjacent to the headspace 128, and/or to a portion of the annular volume 120 that is below the photocatalyst packed bed 126 (i.e., on the opposite side of the photocatalyst packed bed 126 from the headspace 128). In yet another example embodiment, both reflective and scattering surfaces may be included in the outer cell wall 102 and/or the inner cell wall 110, or in other components of the photocatalytic reactor cell 100.

The use of reflective and/or scattering surfaces may help to minimize heat losses from the reactor cell assembly 100. Based on Multiphysics simulation modeling using COMSOL, it has been determined that heat losses may be minimized using one or more of the following principles: (a) utilizing appropriate materials at different parts of the reactor to minimize or advantageously re-use the radiative heat transferred from the energized catalyst bed to other parts of the reactor; (b) utilizing appropriate insulation materials at different parts of the reactor; (c) minimizing the use of metal in the reactor and instead using materials with lower thermal conductivity (e.g., glass or quartz), thus increasing the resistance to heat transfer from the photocatalytic reactor cell assembly 100 to the environment. The reactor cell embodiments described herein operate at much lower temperatures then conventional thermal reactors, allowing for the use of materials such as quartz, aluminum, and ceramics. This may reduce the loss of energy from reactor cell assembly 100, thus potentially increasing energy efficiency compared to conventional reactors.

As illustrated in FIG. 8, a porous base filter 130, also referred to herein as a delimiter, and which may be in the form of a porous ceramic base filter, a metal plate, or other gas-permeable base material or structure, may be included in the annular volume 120 between the outer cell wall 102 and the inner cell wall 110 to position the photocatalyst packed bed 126 in the annular volume 120. When the photocatalytic reactor cell assembly 100 is oriented vertically (perpendicular to the ground) with respect to a gravitational or other force (not shown but assumed to be originating from the bottom of FIG. 8), the porous base filter 130 is preferably located at an underside (i.e., bottom) of the photocatalyst packed bed 126. The porous base filter 130 has a plurality of openings (pores) having a pore size chosen to be gas-permeable (to allow resultant gaseous product(s) to flow through) but impermeable to the photocatalyst packed bed 126. For example, the pore size is chosen to be impermeable to the micron-sized aggregates of the photocatalyst nanoparticles and support material (e.g., aerogel) in the photocatalyst packed bed 126. The porous base filter 130 is constructed of a gas-permeable structural material, such as one of the following, without limitation: porous metal, stainless steel (SS316), an austenitic nickel-chromium-based alloy, a nickel-chromium-iron-molybdenum alloy, quartz wool, or ceramic. If both the outer cell wall 102 and the inner cell wall 110 are cylindrical, then the porous base filter 130 preferably has an annular shape corresponding to the shape of the annular volume 120.

Table 1, below, sets forth example physical dimensions for various example reactor cell embodiments set forth herein:

TABLE 1

| Dimensions | Range | Unit |
|---|---|---|
| Height | 5-200 | cm |
| Annular region inside | 5-275 | cm |
| cylinder inside diameter | | |
| Annular region inside | 5.5-300 | cm |
| cylinder outside diameter | | |
| Annular region outside | 6-300 | cm |
| cylinder inside diameter | | |
| Annular region outside | 6.5-330 | cm |
| cylinder inside diameter | | |
| Catalyst Bed Volume | 0.25-15 | L |

The photocatalytic reactor cell 100 illustrated in FIGS. 5-8 includes a light housing comprising an outer portion 132a and an inner portion 132b. While both an outer portion 132a and an inner portion 132b of the light housing are illustrated, in some embodiments, either of the outer portion 132a or the inner portion 132b may be omitted from the light housing. The outer portion 132a of the light housing is arranged concentrically around the vertical axis 118 outside the outer cell wall 102. The inner portion 132b of the light housing is arranged concentrically around the vertical axis 118 inside the inner cell wall 110. In the example of FIGS. 5-8, both the outer portion 132a and the inner portion 132b have a circumferential array of photon emitters arranged to emit photons (uniformly or in a predetermined radiation pattern) incident on the photocatalyst packed bed 126. The circumferential array of photon emitters 142a of the outer portion 132a of the light housing is arranged to emit photons toward the photocatalyst packed bed 126 (i.e., toward an interior of the outer portion 132a). The circumferential array of photon emitters 142b of the inner portion 132b of the light housing is arranged to emit photons toward the photocatalyst packed bed 126 (i.e., generally away from an interior of the inner portion 132b). For example, the circumferential array of photon emitters 142a may be arranged on an inner surface of the outer portion 132a and the circumferential array of photon emitters 142b may be arranged on an outer surface of the inner portion 132b, in order to emit photons incident on the photocatalyst packed bed 126. As another example, the circumferential array of photon emitters 142a may be arranged as a plurality of bulbs emitting photons toward an interior of the outer portion 132a and the circumferential array of photon emitters 142b may be arranged as a plurality of bulbs emitting photons toward an exterior of the inner portion 132b, in order to emit photons incident on the photocatalyst packed bed 126. The emission of photons incident on the photocatalyst packed bed 126 activates continuous photo-induced gas-phase reactions as at least one gaseous reactant flows through the photocatalyst packed bed 126, producing at least one resultant gaseous product.

In some example embodiments, the outer portion 132a of the light housing is of an outwardly opening clamshell design and comprises two (or more) sections coupled by a hinge (not shown) to allow for installation or removal of the outer portion 132a in the photocatalytic reactor cell assembly 100. Similarly, the inner portion 132b of the light housing may be of an inwardly opening clamshell design comprising two (or more) sections coupled by a hinge (not shown) to allow for installation or removal of the inner portion 132b in the photocatalytic reactor cell assembly 100.

As illustrated in FIGS. 5-8, both the outer portion 132a and the inner portion 132b of the light housing are cylindrical, with a circular cross section. In other embodiments, the outer portion 132a and/or the inner portion 132b of the light housing may have a shape that is non-cylindrical. For example, the outer portion 132a and/or the inner portion 132b of the light housing may have a square, hexagonal, octagonal, or other regular polygonal cross-section, such as to match a cross-sectional shape of the first tube 104 and/or the second tube 112. Moreover, the cross-sectional widths of the outer portion 132a and/or the inner portion 132b may vary over the height (length) of the outer portion 132a and/or the inner portion 132b, such as may be the case if a middle portion of the outer portion 132a and/or the inner portion 132b is wider than end portions. For example, the outer portion 132a and/or the inner portion 132b may have two or more cylindrical portions having different diameters, with each of the cylindrical portions being joined end-to-end via angular connecting portions that serve as size-adapters between the different cylindrical portions the outer portion 132a and/or the inner portion 132b of the light housing.

The exterior of the outer portion 132a of the light housing may be shaped differently than the interior of the outer portion 132a. For example, instead of being cylindrically shaped on both its interior and exterior, the outer portion 132a may be cylindrical on its interior, but surrounded by other equipment, components, and/or materials, such as heat management and/or control equipment, components, and/or materials, giving the exterior a non-cylindrical shape. Similarly, the interior of the inner portion 132b of the light housing may be shaped differently than the exterior of the inner portion 132b. For example, instead of being generally hollow as shown in FIGS. 5-8, the inner portion 132b may instead be solid or filled with other equipment, components, and/or materials.

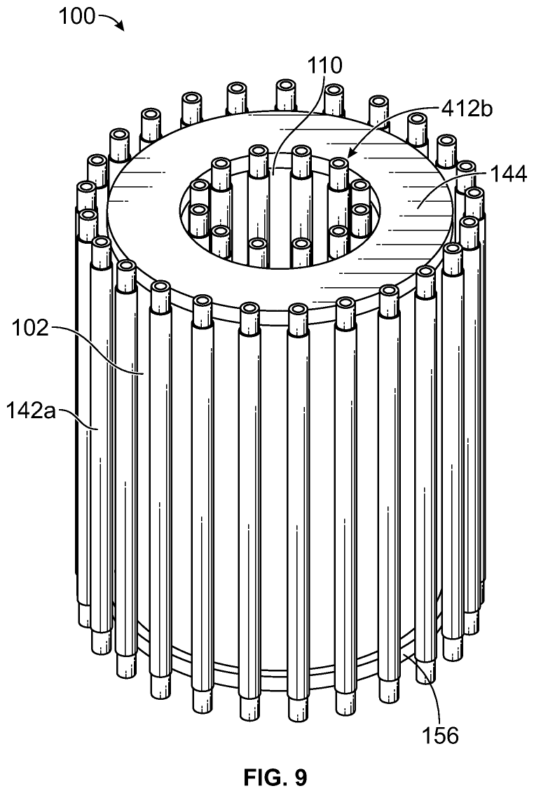

Some or all of the photon emitters in the circumferential array of photon emitters on the outer portion 132a and/or the inner portion 132b may be LEDs mounted on LED circuit boards or in other configurations, as is illustrated in at least FIGS. 5-8. For example, the circumferential array of photon emitters on the outer portion 132a and/or the inner portion 132b may include a plurality of LED boards adjacent to one another, with each LED board comprising a plurality of LEDs, such as thousands of LEDs that are each around 1-5 mm across. The LEDs may be selected to emit photons in the visible light spectrum (i.e., from about 380 nm to about 750 nm), for example. Alternatively or additionally, as illustrated in FIGS. 9-11, described below, some or all of the photon emitters in the circumferential array of photon emitters on the outer portion 132a and/or the inner portion 132b may be infrared (IR) lamps mounted via sockets, connectors, pins, wires, or other configurations, to emit photons in the near-IR spectrum (i.e., from about 750 nm to about 2,500 nm). Further details regarding the use of IR bulbs as photon emitters (and/or heaters) are set forth in International Application No. PCT/US2022/031444 (incorporated by reference herein). Other embodiments may include other types of photon emitters, both artificial (e.g., ultraviolet (UV) lamps and voltaic arc lamps) and natural (e.g., utilizing solar radiation). In general, to promote efficient operation for the photocatalytic reactor cell assembly 100, the photon emitters are selected to emit photons having a sufficient energy and wavelength to activate desired photo-induced gas-phase reactions. One or more embodiments may also include one or more endcap fittings, seals, tension rods, gas inlets, and gas outlets, as described in International Application No. PCT/US2022/031444, for example.

### B. Reactor Cell Assembly Having Cooled Outer and Inner LED Light Housing

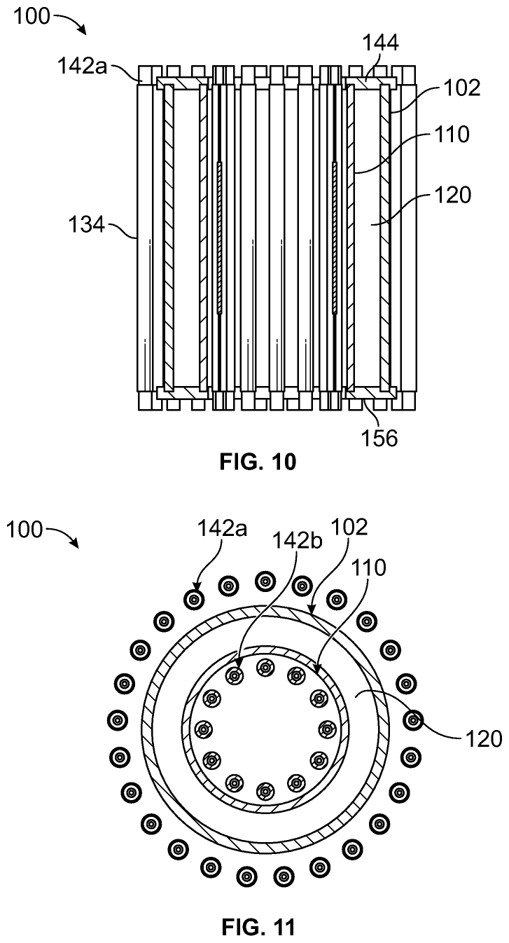

FIG. 9 is an isometric diagram illustrating a reactor cell assembly 100, according to an example embodiment. FIG. 10 is a vertical cross-sectional diagram illustrating a reactor cell assembly 100, according to an example embodiment. FIG. 11 is a horizontal cross-sectional diagram illustrating a reactor cell assembly 100, according to an example embodiment. FIGS. 9-11 may omit some features and/or components from what is shown in various of FIGS. 5-8 (or each other), as appropriate, to permit better illustration and comprehension. For example, FIGS. 9-11 omit (but the described example embodiments may include) details of the outer portion 132a and/or inner portion 132b of the light housing, photocatalyst packed bed 126, porous base filter 130, reactant gas inlet 146, and product gas outlet 158. FIGS. 9-11 are presented primarily to illustrate a variation of the photocatalytic reactor cell 100 in which IR lamps serve as photon emitters and/or heaters in the light housing.

As shown in FIGS. 9-11, a reactor cell assembly 100 includes an outer cell wall 102 around which a plurality of photon emitters 142a, in the form of IR lamps, is circumferentially arranged, serving as an outer portion of a light housing. The reactor cell assembly 100 further includes an inner cell wall 110 inside of which a plurality of photon emitters 142b, in the form of IR lamps, is circumferentially arranged to serve as an inner portion of a light housing. In some embodiments one or the other of the plurality of photon emitters 142a or the plurality of photon emitters 142b is omitted, such that the reactor cell assembly only has an inner portion of a light housing or an outer portion of a light housing. A top compression endcap fitting 144 and a bottom compression endcap fitting 156 form respective top and bottom seals through which only gaseous reactant input(s) and gaseous product output(s) are intended to pass via respective reactant gas inlet(s) and product gas outlet(s), neither of which are illustrated in FIGS. 9-11.

In embodiments in which the reactor cell assembly 100 is a photocatalytic reactor cell assembly, the annular volume 120 between the outer cell wall 102 and the inner cell wall 110 may include a photocatalyst packed bed upon which emitted incident light (e.g., in the near-IR spectrum) from the pluralities of photon emitters 142a and 142b activates continuous photo-induced gas-phase reactions as at least one gaseous reactant flows through the photocatalyst packed bed to produce at least one resultant gaseous product. The IR lamps may additionally supply heat to the photocatalyst packed bed to further catalyze the reaction(s).

### C. Multiphysics Simulation Modeling and Experimental Results

COMSOL modeling was used to model light delivery to the photocatalyst bed for various light housing designs for an annular-shaped reactor cell assembly similar to as illustrated in FIGS. 5-8. This modeling has demonstrated that in some embodiments, an LED-based inner portion of the light housing (i.e., the interior of the annulus of the annular-shaped reactor) is capable of delivering approximately 63% of input electrical energy to the photocatalyst bed, when considering driver loss, electrical-to-heat loss at diode, and light housing loss. Similarly, the modeling demonstrated that an LED-based outer portion of the light housing (i.e., the exterior of the annulus of the annular-shaped reactor) is capable of delivery approximately 55% of input electrical energy to the photocatalyst bed, when considering driver loss, electrical-to-heat loss at diode, and light housing loss. Theoretical calculations were also performed to estimate IR lamp energy delivery efficiency. Based on these theoretical calculations, an example maximum IR energy efficiency to be achieved using various example embodiments disclosed herein is 75%.

To find the light intensity incident on the photocatalyst packed bed 126 and the efficiency of the light housing (inner and/or outer portions), a COMSOL ray-tracing simulation has been employed. Each LED (out of thousands or more of LEDs) acts as a point source of light and emits radiation in the visible spectrum with a certain emissive power. The COMSOL simulation traces representative rays through a geometry representing the light housing and other components of the reactor cell assembly 100. The traced light rays bounce off surfaces based off Snell's law and the Fresnel equations. Each ray loses some energy with each boundary interaction and eventually falls below a certain energy threshold and stops propagating. The photocatalyst packed bed 126 is simulated as highly absorptive so that if a traced ray reaches the photocatalyst 126, it is completely absorbed for purposes of the COMSOL simulation.

The rays emitted from each individual LED (or other light source) are traced, and once all representative rays for all LEDs have been traced through the light housing geometry, the accumulated energy (in watts) that is deposited at each boundary is then divided by the area of the underlying mesh (e.g., a finite element mesh comprising triangles). This gives an intensity at each surface (e.g., triangular mesh surface segment) that may be used as a heat source for further heat transfer/fluid flow simulations. Mathematically, the resulting light intensity on any triangular mesh surface is:

$${I}_{i} = \frac{1}{{A}_{i}} {\sum }_{j} {Q}_{j} \qquad Equation 8$$

where I is intensity in W/m², A is area in m², and Q is the power of a ray in W. Here the subscript i represents the index of mesh triangle and the subscript j represents the index of rays that have accumulated on that specific mesh triangle.

Table 2, below, illustrates experimental results and design calculations demonstrating performance of example embodiments of the reactor cell assembly set forth herein, using Photocatalytic Steam Methane Reformation (PSMR) as an example reaction. As can be seen, the conversion percentage is 83% for both experimental results and design calculations, which is believed to be a significant improvement over typical hydrogen-producing reactors.

TABLE 2

| | Experimental | Design |
|---|---|---|
| | Results | calculations |
| Reactor volume (L) | 0.013 | 0.263 |
| GHSV (h⁻¹) | 6500 | 6500 |
| Steam:Methane Ratio | 2 | 2 |
| Hydrogen Generated (Kg/day) | 0.175 | 3.4 |
| Conversion (%) | 83% | 83% |
| Energy Efficiency (%) | 40% | 50% |
| Electrical Energy used (W) | 407 | 5000 |

### V. AMMONIA DECOMPOSITION TEST RESULTS

Photocatalyst support material extrudates were produced using a method generally in accordance with the second example method 470 set forth herein. The extrudates were loaded into a photocatalytic cell to test ammonia decomposition relative to powder photocatalyst. Table 3, below, sets for the observed decomposition results.

TABLE 3

| | | Powder | Powder | |
|---|---|---|---|---|
| | Units | (35-60) | (14-20) | Extrudate |
| H₂ Prod Rate | kg/day | 245 | 238 | 223 |
| Ammonia | % | 94.6% | 92.0% | 86.1% |
| Conversion | | | | |
| Energy | % | 79.2% | 77.6% | 72.1% |
| Efficiency | | | | |
| (bench scale) | | | | |
| kWh/kgH₂ | | 11.2 | 11.3 | 12.3 |
| (bench scale) | | | | |
| Pressure | % | | 74.8% | 95.1% |
| Drop | | | | |
| Improvement | | | | |
| Compared to | | | | |
| 35-60 | | | | |
| Crush | N | | | 14.4 ± 3.9 |
| Strength | | | | |
| BET Surface | m²/g | 110 | 113 | 62 |
| Area | | | | |

As shown in Table 3, the photocatalyst support material extrusion process in accordance with the second example method 470 utilizing binder, porogen, and solvent prior to extruding provide about a 95.1% lower pressure drop than powder photocatalyst particles. This reduced pressure drop occurred while maintaining a desired activity of >200 kg/day hydrogen production rate with an activity loss of ˜4%. The produced extrudates exhibited a crushing strength of ˜14 N and a surface area ˜60 m²/g, both of which are well-suited to photocatalysis for industrial chemical production.

### VI. EMBODIMENT EXAMPLES

The following numbered examples are embodiments.

Example 1. A method for producing an extrudate photocatalyst for a continuous-flow fixed-bed gas-phase photoreactor, the method comprising: co-precipitating at least two solutions to deposit an active metal on a support, thereby forming a slurry; centrifugating the slurry to form a paste in which unreacted chemicals, byproducts, and excess solvent from the co-precipitating have been removed; drying the paste to form a dried powder; milling the dried powder to form a milled dried powder having a relatively homogeneous size of catalyst particles; mixing the milled dried powder with a binder, a porogen, and a peptizing agent to produce a mixture; adding a solvent to the mixture to form a dough; feeding the dough through an extruder to create extrudates having a predetermined shape and cross-section; drying the extrudate; and thermally treating the extrudate after drying.

Example 2. The method of Example 1, further comprising selecting amounts of the peptizing agent and the solvent to form the dough such that the extrudates, after the drying and thermally treating, will have a correspondingly proportional crushing strength and porosity.

Example 3. The method of any of the preceding Examples, further comprising cutting the extrudates to create extrudates having a shorter length.

Example 4. The method of any of the preceding Examples, wherein the binder is an organic binder.

Example 5. The method of any of the preceding Examples, wherein the binder comprises guar gum.

Example 6. The method of any of the preceding Examples, wherein the binder decomposes during the drying of the extrudate to thereby increase porosity of the extrudate.

Example 7. The method of any of Examples 1-3, wherein the binder comprises a binder selected from the group consisting of alumina, silica, silica-alumina, titania, zirconia, and national clay.

Example 8. The method of any of the preceding Examples, wherein the porogen is selected from the group consisting of a starch, a flax, and a carbon black material.

Example 9. The method of any of the preceding Examples, wherein the porogen thermally decomposes during the drying of the extrudate to thereby remove the porogen from the extrudate.

Example 10. The method of any of the preceding Examples, wherein at least one of the at least two solutions comprises a photocatalytic material selected from plasmonic and non-plasmonic metals, metal oxides, semiconductors, oxides, or materials with free carriers.

Exampl39999date without melting the extrudate.

Example 11b. The method of any of the preceding Examples, wherein thermally treating the extrudate comprises calcination of the extrudate in the presence of air at a temperature range of 150-800° C. for more than 2 hours.

Example 12a. The method of any of Examples 1-10, wherein thermally treating the extrudate comprises reduction of the extrudate in the presence of hydrogen at an elevated temperature for a predetermined time period.

Example 12b. The method of any of Examples 1-10, wherein thermally treating the extrudate comprises reduction of the extrudate in the presence of hydrogen at a temperature range of at least 150-800° C. for at least 2 hours.

Example 13. The method of any of the preceding Examples, further comprising (a) analyzing solvent content in the paste formed via centrifugation to determine if the paste has a solvent content within a predetermined range, and (b) if not, adjusting duration of the centrifugation.

Example 14. The method of any of the preceding Examples, wherein the extruder comprises a die having a plurality of holes through which the paste or dough is fed, and wherein the shape and dimension of each of the plurality of holes are selected to define a cross-sectional shape and dimension of the extrudate.

Example 15. The method of Examples 14, wherein the holes are circular with a diameter of at least 1 mm and wherein the extrudates have a circular cross section with a diameter of at least 1 mm.

Example 16. The method of any of Examples 3-15, wherein cutting the extrudates to create extrudates having the shorter length comprises cutting the extrudates to have a length-to-diameter ratio of at least 10, and wherein the diameter is at least 1 mm.

Example 17. The method of any of Examples 3-15, wherein cutting the extrudates to create extrudates having a shorter length comprises cutting the extrudates to have a length-to-diameter ratio of 100, and wherein the diameter is at least 1 mm.

Example 18. The method of any of Examples 3-15, wherein cutting the extrudates to create extrudates having a shorter length comprises cutting the extrudates to have a length-to-diameter ratio of 1000, and wherein the diameter is at least 1 mm.

Example 19. The method of Example 14, wherein the shape of each of the holes is selected from the group consisting of a circle, a cloverleaf, a dumbbell, a symmetrical polylobate, or an asymmetrical polylobate, to thereby cause each of the extrudates to have corresponding respective cross-sectional shapes selected from the group consisting of the circle, the cloverleaf, the dumbbell, the symmetrical polylobate, or the asymmetrical polylobate.

Example 20. The method of any of the preceding Examples, wherein the extrudates have a crushing strength of at least 10 N/mm².

Example 21. The method of any of the preceding Examples, wherein the extrudates have optical and chemical properties substantially matching those of the dried powder.

Example 22. The method of any of the preceding Examples, further comprising loading the extrudates as a photocatalyst packed bed into the continuous-flow fixed-bed gas-phase photoreactor.

Example 23. The method of Example 22, wherein loading the extrudates comprises positioning the extrudates on a delimiter as the photocatalyst packed bed in an annular volume of the photoreactor between an outer cell wall of the photoreactor and an inner cell wall of the photoreactor.

Example 24. The method of Example 22 or Example 23, wherein the photoreactor is constructed of glass or quartz, further comprising passing a feed gas through the photocatalyst packed bed comprising the extrudates

Example 25. An extrudate photocatalyst produced in accordance with the method of any of the preceding Examples.

Example 26. A photocatalytic reactor cell assembly, comprising:
an outer cell wall comprising a first tube having a first outer diameter and a first inner diameter;
an inner cell wall comprising a second tube having a second outer diameter and a second inner diameter, wherein the second outer diameter is smaller than the first inner diameter, wherein the outer cell wall and the inner cell wall are arranged concentrically about a vertical axis to define an annular volume between the outer cell wall and the inner cell wall, and wherein at least one of the outer cell wall or the inner cell wall is constructed of glass or quartz;
a top compression endcap fitting having an annular shape and comprising a reactant gas inlet;
a bottom compression endcap fitting having an annular shape and comprising a product gas outlet, wherein the top compression endcap fitting and the bottom compression endcap fittings respectively form a top seal and a bottom seal with the outer cell wall and the inner cell wall;
a photocatalyst packed bed positioned in the annular volume between the outer cell wall and the inner cell wall, wherein the photocatalyst packed bed comprises an extruded mesoporous photocatalyst having a crushing strength of at least 10 N/mm²;
a porous base filter to position the photocatalyst packed bed in the annular volume, wherein the porous base filter is on an underside of the photocatalyst packed bed closer to the bottom compression endcap fitting than to the top compression endcap fitting, and wherein the porous base filter has a pore size chosen to be gas permeable but impermeable to the photocatalyst in the photocatalyst packed bed; and
a light housing comprising a circumferential array of photon emitters arranged to emit photons incident on the photocatalyst packed bed,
whereby the emission of photons incident on the photocatalyst packed bed activates continuous photo-induced gas-phase reactions as at least one gaseous reactant introduced via the gas inlet flows through the photocatalyst packed bed and at least one resultant gaseous product exits via the gas outlet.

Example 27. The photocatalytic reactor cell assembly of Example 26, wherein the porosity of the extruded mesoporous photocatalyst is in a range of 0.3-0.45.

Example 28. A method comprising: mixing a photocatalyst powder, a binder, and a porogen to create homogeneous mixture; adding a solvent to the homogeneous mixture while stirring the homogeneous mixture, wherein the solvent comprises water or diluted acid; mixing the solvent and the homogeneous mixture to form a thickened wet dough material; feeding the thickened wet dough material through an extruder having an extruder auger tube terminating at a die having holes of predetermined shape and cross-section to thereby create a plurality of extrudates having the predetermined shape and cross-section; cutting the plurality of extrudates with a cutter to create a plurality of cut extrudates having a desired cross-section-to-length aspect ratio; drying the plurality of cut extrudates; and applying a thermal treatment to the plurality of cut extrudates.

Example 29. A photocatalyst extrudate produced via the method of Example 28.

Example 30. The photocatalyst extrudate of Example 29, wherein the photocatalyst extrudate has a crushing strength of at least 10 N/mm² and a porosity in a range of 0.3-0.45.

### VII. CONCLUSION

The above detailed description sets forth various features and operations of the disclosed systems, apparatus, devices, and/or methods with reference to the accompanying figures. The example embodiments described herein and in the figures are not meant to be limiting, with the true scope being indicated by the following claims. Many modifications and variations can be made without departing from its scope, as will be apparent to those skilled in the art. Functionally equivalent systems, apparatus, devices, and/or methods within the scope of the disclosure, in addition to those described herein, will be apparent to those skilled in the art from the foregoing descriptions. It will be readily understood that the aspects of the present disclosure, as generally described herein, and illustrated in the figures, can be arranged, substituted, combined, separated, and designed in a wide variety of different configurations. Such modifications and variations are intended to fall within the scope of the appended claims. Finally, all publications, patents, and patent applications cited herein are hereby incorporated herein by reference for all purposes.

1. A method for producing an extrudate photocatalyst comprising:
co-precipitating at least two solutions to deposit an active metal on a support, thereby forming a slurry;
centrifugating the slurry to form a paste in which unreacted chemicals, byproducts, and excess solvent from the co-precipitating have been removed;
drying the paste to form a dried powder;
milling the dried powder to form a milled dried powder having a homogeneous size of catalyst particles;
mixing the milled dried powder with a binder, a porogen, and a peptizing agent to produce a mixture;
adding a solvent to the mixture to form a dough;
feeding the dough through an extruder to create one or more extrudates each having a predetermined shape and cross-section;
drying the extrudates; and
thermally treating the extrudates after drying.

2. The method of claim 1, further comprising selecting amounts of the peptizing agent and the solvent to form the dough such that the extrudates, after the drying and thermally treating, will have a correspondingly proportional crushing strength and porosity.

3. The method of claim 1, further comprising cutting the extrudates to create extrudates having a shorter length.

4. The method of claim 1, wherein the binder is an organic binder.

5. (canceled)

6. (canceled)

7. The method of claim 1, wherein the binder is selected from the group consisting of guar gum, alumina, silica, silica-alumina, titania, zirconia, and national clay.

8. The method of claim 1, wherein the porogen is selected from the group consisting of a starch, a flax, and a carbon black material.

9. The method of claim 1, wherein the porogen thermally decomposes during the drying of the extrudates to thereby remove the porogen from the extrudates.

10. The method of claim 1, wherein at least one of the at least two solutions comprises a photocatalytic material selected from plasmonic and non-plasmonic metals, metal oxides, semiconductors, oxides, or materials with free carriers.

11. (canceled)

12. The method of claim 1, wherein thermally treating the extrudates comprises reduction of the extrudates in the presence of hydrogen at a temperature range of at least 150-800° C. for at least 2 hours.

13. (canceled)

14. The method of claim 1, wherein the extruder comprises a die having one or more holes through which the paste or dough is fed, and wherein the shape and dimension of each of the holes are selected to respectively define a cross-sectional shape and dimension of each of the extrudates.

15. The method of claim 14, wherein the holes are circular with a diameter of at least 1 mm and wherein the extrudates have a circular cross section with a diameter of at least 1 mm.

16. The method of claim 3, wherein cutting the extrudates to create extrudates having the shorter length comprises cutting the extrudates to have a length-to-diameter ratio of at least 10, and wherein the diameter is at least 1 mm.

17. (canceled)

18. (canceled)

19. The method of claim 14, wherein the shape of each of the holes is selected from the group consisting of a circle, a cloverleaf, a dumbbell, a symmetrical polylobate, or an asymmetrical polylobate, to thereby cause each of the extrudates to have corresponding respective cross-sectional shapes selected from the group consisting of the circle, the cloverleaf, the dumbbell, the symmetrical polylobate, or the asymmetrical polylobate.

20. The method of claim 1, wherein the extrudates have a crushing strength of at least 10 N/mm².

21. The method of claim 1, wherein the extrudates have optical and chemical properties substantially matching those of the dried powder.

22. The method of claim 1, further comprising loading the extrudates as a photocatalyst packed bed into a photoreactor, wherein the extrudates reduce a pressure drop in the photoreactor compared to a non-extrudate photocatalyst.

23. The method of claim 22, wherein loading the extrudates comprises positioning the extrudates on a delimiter as the photocatalyst packed bed in an annular volume of the photoreactor between an outer cell wall of the photoreactor and an inner cell wall of the photoreactor.

24. (canceled)

25. An extrudate photocatalyst produced in accordance with the method of claim 1.

26. A photocatalytic reactor cell assembly, comprising:
an outer cell wall comprising a first tube having a first outer diameter and a first inner diameter;
an inner cell wall comprising a second tube having a second outer diameter and a second inner diameter, wherein the second outer diameter is smaller than the first inner diameter, wherein the outer cell wall and the inner cell wall are arranged concentrically about a vertical axis to define an annular volume between the outer cell wall and the inner cell wall, and wherein at least one of the outer cell wall or the inner cell wall is constructed of glass or quartz;
a top compression endcap fitting having an annular shape and comprising a reactant gas inlet;
a bottom compression endcap fitting having an annular shape and comprising a product gas outlet, wherein the top compression endcap fitting and the bottom compression endcap fittings respectively form a top seal and a bottom seal with the outer cell wall and the inner cell wall;
a photocatalyst packed bed positioned in the annular volume between the outer cell wall and the inner cell wall, wherein the photocatalyst packed bed comprises an extruded mesoporous photocatalyst having a crushing strength of at least 10 N/mm², and wherein the extruded mesoporous photocatalyst reduces a pressure drop in the photocatalytic reactor cell compared to a non-extrudate photocatalyst;
a porous base filter to position the photocatalyst packed bed in the annular volume, wherein the porous base filter is on an underside of the photocatalyst packed bed closer to the bottom compression endcap fitting than to the top compression endcap fitting, and wherein the porous base filter has a pore size chosen to be gas permeable but impermeable to the extruded mesoporous photocatalyst in the photocatalyst packed bed; and
a light housing comprising a circumferential array of photon emitters arranged to emit photons incident on the photocatalyst packed bed,
whereby emitted photons incident on the photocatalyst packed bed activate continuous photo-induced gas-phase reactions as at least one gaseous reactant introduced via the gas inlet flows through the photocatalyst packed bed and at least one resultant gaseous product exits via the gas outlet.

27. (canceled)

28. A method comprising:
mixing a photocatalyst powder, a binder, and a porogen to create a homogeneous mixture;
adding a solvent to the homogeneous mixture while stirring the homogeneous mixture, wherein the solvent comprises water or diluted acid;
mixing the solvent and the homogeneous mixture to form a thickened wet dough material;
feeding the thickened wet dough material through an extruder having an extruder auger tube terminating at a die having holes of predetermined shape and cross-section to thereby create a plurality of extrudates having the predetermined shape and cross-section;
cutting the plurality of extrudates with a cutter to create a plurality of cut extrudates having a desired cross-section-to-length aspect ratio;
drying the plurality of cut extrudates; and
applying a thermal treatment to the plurality of cut extrudates.

29. A photocatalyst extrudate produced via the method of claim 28, wherein the photocatalyst extrudate has a crushing strength of at least 10 N/mm² and a porosity in a range of 0.3-0.45.

30. (canceled)

31. The method of claim 3, further comprising shaping the extrudates having the shorter length into a sphere using a spheronizer, wherein the extrudates having the shorter length comprises a length-to-diameter ratio of at least 1, and wherein the diameter is at least 1 mm.
